(19) United States
(12) Patent Application Publication
(10) Pub. No.: US 2025/0308249 A1
(43) Pub. Date: Oct. 2, 2025

(54) Method and Device for Recognizing Distant Object by Vehicle with Autonomous Driving

(71) Applicants: Hyundai Motor Company, Seoul (KR); Kia Corporation, Seoul (KR)

(72) Inventors: Eun Seok Jeon, Hwaseong-Si (KR); Dong Hyun Kim, Hwaseong-Si (KR); Yong Cheon Na, Hwaseong-Si (KR); Jun Ho Song, Hwaseong-Si (KR)

(21) Appl. No.: 18/953,407

(22) Filed: Nov. 20, 2024

(30) Foreign Application Priority Data
Apr. 2, 2024 (KR) 10-2024-0044516

(51) Int. Cl. G06V 20/58; G06T 3/40; G06T 7/536

(52) U.S. Cl. CPC G06V 20/58; G06T 3/40; G06T 7/536; G06T 2207/30252

(57) ABSTRACT

The present disclosure relates to a method and device for a distant object in a vehicle capable of autonomous driving. A method performed by an apparatus of a vehicle may include obtaining, via a camera of the vehicle, an image of an exterior view from the vehicle, generating a cropped image of a distant region in the obtained image, performing first object recognition on the cropped image of the distant region, wherein the cropped image has an original resolution of the obtained image, performing second object recognition on a processed image associated with the obtained image, wherein the processed image has a down-sampled resolution of the obtained image, performing third object recognition by matching a result of the first object recognition with a result of the second object recognition, and controlling, based on a result of the third object recognition, an operation of the vehicle.

### CROSS REFERENCE TO RELATED APPLICATION

The present application claims priority to a Korean Patent Application No. 10-2024-0044516, filed on Apr. 2, 2024 in the Korean Intellectual Property Office, the entire contents of which are incorporated herein for all purposes by reference.

### TECHNICAL FIELD

The present disclosure relates to a method and device for object recognition by a vehicle.

### BACKGROUND

An increasing number of moving objects, such as vehicles, are equipped with autonomous driving capability for driving convenience. Autonomous driving functions are being developed to enable full autonomous driving where a moving object has full control of driving without a driver intervention and under all circumstances. Recognition of a moving object or an object around the moving object and path prediction may be important for autonomous driving.

### SUMMARY

The present disclosure is technically directed to providing a method and device for efficiently recognizing a distant object in a moving object capable of autonomous driving.

In addition, the present disclosure is technically directed to providing a method and device for searching a distant region of interest and compensating for object recognition information of an image recognition network by using high-resolution original image information for the region.

The technical problems solved by the present disclosure are not limited to the above technical problems and other technical problems which are not described herein will be clearly understood by a person having ordinary skill in the technical field, to which the present disclosure belongs, from the following description.

According to one or more example embodiments of the present disclosure, a method performed by an apparatus of a vehicle may include: obtaining, via a camera of the vehicle, an image of an exterior view from the vehicle; generating a cropped image of a distant region in the obtained image; performing first object recognition on the cropped image of the distant region, wherein the cropped image has an original resolution of the obtained image; performing second object recognition on a processed image associated with the obtained image, wherein the processed image has a down-sampled resolution of the obtained image; performing third object recognition by matching a result of the first object recognition with a result of the second object recognition; and controlling, based on a result of the third object recognition, an operation of the vehicle.

Performing the first object recognition may include inputting the cropped image having the original resolution into a first object recognition network.

Performing the second object recognition may include inputting the processed image having the down-sampled resolution into a second object recognition network.

Performing the first object recognition may further include determining, based on information associated with the vehicle, whether recognition of a distant object is necessary.

The information associated with the vehicle may include at least one of: location information, speed information, steering information, or heading indication information.

Generating the cropped image may include: determining a vanishing point in the obtained image; and determining the distant region by determining a region of interest that comprises the vanishing point.

Determining the distant region may include: setting, based on camera calibration information of the vehicle, the vanishing point as a reference point for the region of interest having the original resolution.

Determining the distant region may further include storing scaling information of the region of interest with the original resolution.

Performing the first object recognition may include receiving, based on a first object recognition network, a first object recognition heat map of the distant region.

Performing the second object recognition may include receiving a second object recognition heat map for an overall region of the obtained image.

Performing the third object recognition may include: generating an aligned heat map by: scaling the first object recognition heat map of the distant region according to scaling information of the distant region; and matching the scaled first object recognition heat map with the second object recognition heat map for the overall region; and performing, based on the aligned heat map, the third object recognition.

According to one or more example embodiments of the present disclosure, a vehicle may include: a camera; memory storing computer-readable instructions; and at least one processor. The at least one processor may be configured to execute the computer-readable instructions to cause the vehicle to: obtain, via the camera, an image of an exterior view from the vehicle; generate a cropped image of a distant region in the obtained image; perform first object recognition on the cropped image of the distant region, wherein the cropped image has an original resolution of the obtained image; perform second object recognition on a processed image associated with the obtained image, wherein the processed image has a down-sampled resolution of the obtained image; perform third object recognition by matching a result of the first object recognition with a result of the second object recognition; and control, based on a result of the third object recognition, an operation of the vehicle.

The at least one processor may be configured to execute the computer-readable instructions to cause the vehicle to perform the first object recognition by inputting the cropped image having the original resolution to a first object recognition network.

The at least one processor may be configured to execute the computer-readable instructions to cause the vehicle to perform the second object recognition by inputting the processed image having the down-sampled resolution to a second object recognition network.

The vehicle may further include a sensor for obtaining information associated with the vehicle. The at least one processor may be configured to execute the computer-readable instructions to cause the vehicle to perform the first object recognition further by determining, based on the information associated with the vehicle, whether recognition of a distant object is necessary.

The information associated with the vehicle may include at least one of: location information, speed information, steering information, or heading indication information.

The at least one processor may be configured to execute the computer-readable instructions to cause the vehicle to generate the cropped image by: determining a vanishing point in the obtained image; and determining the distant region by determining a region of interest that comprises the vanishing point.

The at least one processor may be configured to execute the computer-readable instructions to cause the vehicle to determine the distant region by: setting, based on camera calibration information of the vehicle, the vanishing point as a reference point for the region of interest having the original resolution.

The at least one processor may be configured to execute the computer-readable instructions to cause the vehicle to determine the distant region by storing scaling information of the region of interest with the original resolution.

The at least one processor may be configured to execute the computer-readable instructions to cause the vehicle to perform the first object recognition by receiving, based on a first object recognition network, an object recognition heat map of the distant region.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

FIG. 1 is a view exemplifying a concept of a moving object capable of autonomous driving that transmits and receives data in communication with a neighbor device.

FIG. 2 illustrates a configuration of a moving object.

FIG. 3, FIG. 4, and FIG. 5 illustrate examples of applying distant object recognition.

FIG. 6 illustrates a detailed flowchart of an object recognition method capable of recognizing a distant object.

FIG. 7 illustrates a detailed flowchart of processing of first object recognition that derives a first object recognition result, in accordance with an aspect of the present disclosure.

FIG. 8 illustrates a detailed flowchart of processing of second object recognition that derives a second object recognition result, in accordance with an aspect of the present disclosure.

FIG. 9 illustrates a detailed flowchart of recognizing an object by matching a first object recognition result with a second object recognition result, in accordance with an aspect of the present disclosure.

FIG. 10 illustrates an example method of matching a first object recognition result with a second object recognition result in accordance with an aspect of the present disclosure.

FIG. 11 illustrates another detailed configuration of a moving object capable of autonomous driving.

### DETAILED DESCRIPTION

Hereinafter, aspects of the present disclosure will be described in detail with reference to the accompanying drawings, which will be easily implemented by those skilled in the art. However, the present disclosure may be embodied in many different forms and is not limited to the aspects described herein.

In the following description of the aspects of the present disclosure, a detailed description of known functions and configurations incorporated herein will be omitted when it may make the subject matter of the present disclosure rather unclear. In addition, parts not related to the description of the present disclosure in the drawings are omitted, and like parts are denoted by similar reference numerals.

In the present disclosure, when a component is said to be “connected”, “coupled” or “linked” with another component, this may include not only a direct connection, but also an indirect connection in which another component exists in the middle therebetween. In addition, when a component “includes” or “has” other components, it means that other components may be further included rather than excluding other components unless the context clearly indicates otherwise.

In the present disclosure, terms such as first and second are used only for the purpose of distinguishing one component from other components, and do not limit the order, importance, or the like of components unless otherwise noted. Accordingly, within the scope of the present disclosure, a first component in an example may be referred to as a second component in another example, and similarly, a second component in an example may also be referred to as a first component in another example.

In the present disclosure, components that are distinguished from each other are intended to clearly describe each of their characteristics, and do not necessarily mean that the components are separated from each other. That is, a plurality of components may be integrated into one hardware or software unit, or one component may be distributed to be configured in a plurality of hardware or software units. Therefore, even when not stated otherwise, such integrated or distributed embodiments are also included in the scope of the present disclosure.

In the present disclosure, components described in various examples do not necessarily mean essential components, and some may be optional components. Accordingly, a configuration consisting of a subset of components described in an example is also included in the scope of the present disclosure. In addition, embodiment(s) including other components in addition to the components described in the various embodiment(s) are included in the scope of the present disclosure.

The merits and characteristics of the present disclosure and a method of achieving the merits and characteristics will become more apparent from the embodiment(s) described in detail in conjunction with the accompanying drawings. However, the present disclosure is not limited to the disclosed embodiment(s), but may be implemented in various different ways. The examples are provided to only complete the present disclosure and to allow those skilled in the art to fully understand the category of the disclosure.

In the field of image processing using artificial intelligence (AI), an object may be a thing or a person that is distinguishable from one another. In the present disclosure, an object may refer to any distinct thing (e.g., an inanimate object or any non-human object or entity) or a person (e.g., a human).

In at least some implementations, an object in a distant region may still be difficult to accurately recognize. Specifically, when objects around an autonomous vehicle are recognized using a camera installed in the vehicle and driving information is updated, image-recognition networks may use down-sampled images to reduce resource usage. If an image is down-sampled, a pixel size (e.g., a number of pixels) representing an object may be reduced according to the decrease in scale. Consequently, because a minimum object size recognizable in an image recognition network may be a fixed value, a distant object may become smaller than a minimum recognizable size, thereby degrading the success rate of object recognition.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., object recognition using a down-sampled image data) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., object recognition using a down-sampled image data) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., object recognition using a down-sampled image data) described herein.

Minimum risk maneuver (MRM) operation(s) may also be controlled, for example, based on one or more features (e.g., object recognition using a down-sampled image data) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., object recognition using a down-sampled image data) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., object recognition using a down-sampled image data) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

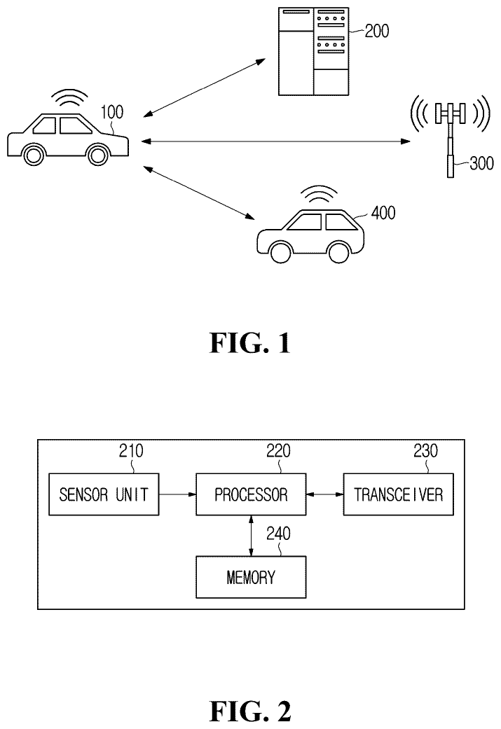

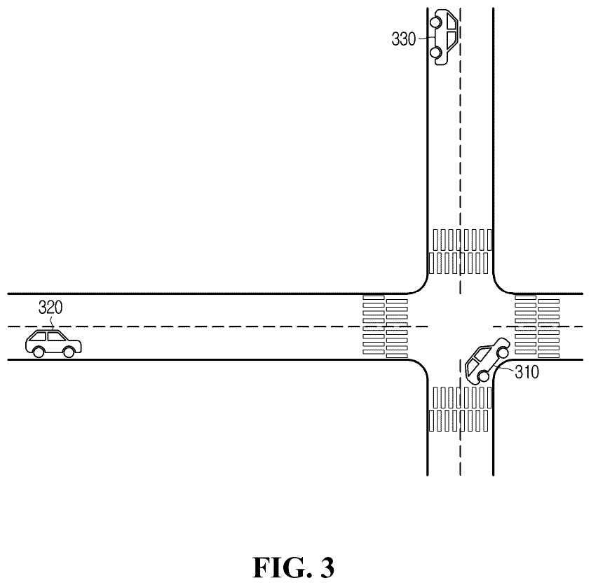

Hereinafter, referring to FIG. 1 to FIG. 2, a conceptual relationship between a moving object and a neighbor device will be described in accordance with an aspect of the present disclosure. First, FIG. 1 is a view exemplifying a concept of a moving object that transmits and receives data in communication with another device.

The moving object 100 may refer to a device capable of moving. The moving object may be a vehicle. The moving object 100 is a ground moving object that is driven on the ground and may be a normal passenger vehicle or commercial vehicle, a purpose built vehicle (PBV), and the like. In addition, the moving object 100 may be a four-wheel vehicle such as a sedan, a sports utility vehicle (SUV), and a pickup truck and may also be a moving object with five or more wheels such as a bus, a lorry, a moving object carrying a container, and a moving object carrying heavy equipment. The moving object 100 may be a manned vehicle or an unmanned vehicle (e.g., having no drivers or passengers).

Meanwhile, the moving object 100 may perform communication with an external server 200, an external infrastructure device 300 or another moving object 400.

For example, the server 200 may be an external device operated by a moving object manufacturer or provided for an autonomous driving service and may receive connected data of the moving object 100 or transmit data necessary for autonomous driving. In order to support autonomous driving and various services for the moving object 100, the server 200 may transmit various types of information and software modules used for controlling the moving object 100 to the moving object 100 as a response to a request and data transmitted from the moving object 100 and a user device. However, in case the moving object 100 itself is capable of processing information and a module provided from the server 200 (e.g. ‘on-device AI function’), the moving object 100 may also generate and execute its own data needed for autonomous driving without communicating with the server 200.

For example, according to the present disclosure, the server 200 may be an object recognition network that executes an object recognition result of a moving object. That is, the server 200 may receive information for object recognition, perform object recognition based on the information, and then deliver a corresponding result to the moving object 100.

In addition, for example, according to the present disclosure, the server 200 may be configured as a plurality of object recognition networks. For example, the server 200 may be configured by including a first object recognition network, which performs object recognition for a distant region with an original resolution, and a second object recognition network that performs object recognition for an overall image with a downsampled resolution. However, a plurality of object recognition networks are an example for describing the present disclosure, and the first object recognition network and the second object recognition network may also be configured as a single module. In this regard, the first object recognition network and the second object recognition network will be described in detail below.

On the other hand, as described above, the first object recognition network and the second object recognition network may also be provided inside the moving object 100, and a lot of resources may be required in this case.

In addition, for example, according to the present disclosure, the infrastructure device 300 may be an intelligent transportation system (ITS) device. However, this is merely an example, and the present disclosure is not limited thereto. Accordingly, a CCTV installed at a road side may also be an infrastructure device according to the present disclosure. As an example of the infrastructure device, the ITS device 300 may be a road side unit (RSU). As the infrastructure device, the ITS device 300 may assist a user in driving his own car or support autonomous driving of the moving object 100 by exchanging vehicle recognition data, driving control and situation data, environment data surrounding a moving object, and map data through V2I with the moving object 100.

In addition, the first object recognition network and/or the second object recognition network may be provided in the infrastructure device 300. For example, the infrastructure device 300 may include both the first object recognition network and the second object recognition network. Alternatively, only the first object recognition network for distant object recognition may be included, while the second object recognition network for overall region recognition may not be included. Alternatively, the opposite case may also be possible. An object recognition network not included in the infrastructure device 300 may be configured in the server 200.

In addition, through V2V with the another moving object 400, the moving object 100 may support a driver's driving his own car or autonomous driving by exchanging the above-listed data. The moving object 100 may communicate with another moving object or another device based on cellular communication, wireless access in vehicular environment (WAVE) communication, dedicated short range communication (DSRC) or short range communication, or any other communication scheme.

FIG. 2 is a schematic diagram showing a configuration of a moving object 100 capable of autonomous driving. For example, a moving object according to the present disclosure may be implemented at least with a sensor unit 210, a processor 220 for performing an operation, a transceiver 230 for performing data transmission and reception to and from outside, and a memory 240 for storing an instruction for executing the processor 220 and system data.

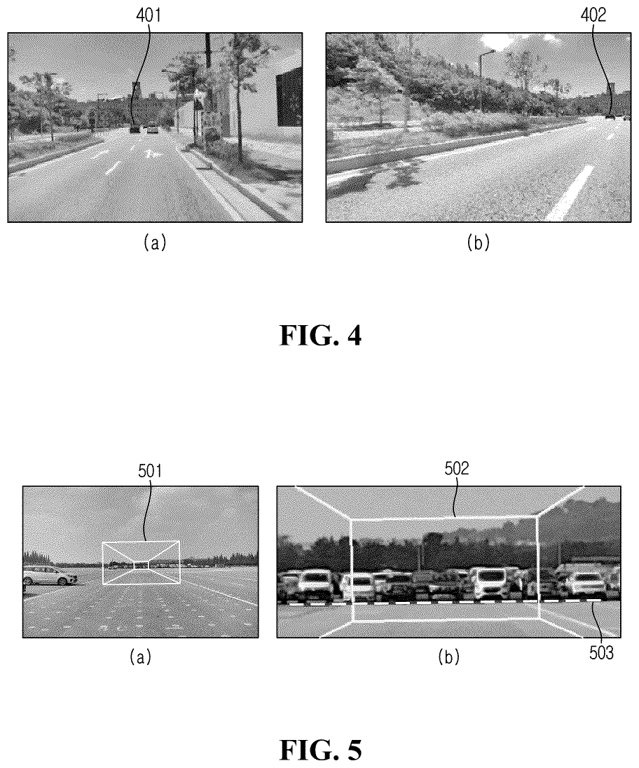

FIG. 3, FIG. 4, and FIG. 5 illustrate examples of applying distant object recognition.

For example, in case an autonomous driving moving object 310 attempts to make a left turn at an intersection, the autonomous driving moving object 310 needs to accurately recognize other moving objects 320 and 330 that are coming far away from the front and the far left side, respectively, on the road. However, for example, as shown in (a) or (b) of FIG. 4, if such vehicles are located in distant regions 401 and 402, it is difficult to clearly recognize types and shapes of objects.

Accordingly, the present disclosure is directed to providing a method for recognizing an object in a distant region more accurately. For example, as illustrated in (a) and (b) of FIG. 5, a portion of a peripheral region 501 near a distant vanishing point may be cropped and specified as a region of interest (502), and the specified region of interest may be retained with an original resolution, thereby performing object recognition. Herein, in the present disclosure, ‘crop’ refers to an image processing technology of cutting off and specifying a portion of an image and may be understood to encompass even a case of performing a same or similar function but using a different term in the technical field.

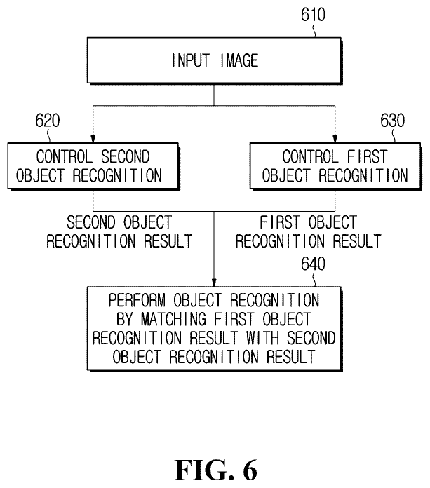

Hereinafter, referring to FIG. 6 to FIG. 10, an object recognition method capable of recognizing a distant object will be described in detail.

First, FIG. 6 illustrates a detailed flowchart of an object recognition method capable of recognizing a distant object. As shown in FIG. 6, the object recognition method capable of recognizing a distant object may consist of receiving an input image (S610), controlling first object recognition that derives a first object recognition result (S630), controlling second object recognition that derives a second object recognition result (S620), and performing final object recognition by matching the first object recognition result with the second object recognition result (S640).

Specifically, at the step S610 of receiving the input image, the input image may be obtained through a camera installed in an autonomous driving moving object. The image may be of an exterior view from the vehicle.

In addition, the step S630 of controlling the first object recognition crops and specifies a distant region in the input image received at the step S610 and controls to derive first object recognition for an original resolution image of the specified distant region. Herein, the step S630 of controlling the first object recognition controls to deliver the original resolution image of the specified distant region to a first object recognition network in order to perform the first object recognition. For example, as described above, the first object recognition network may be present in the server 200 or the infrastructure device 300 outside the moving object 100. Accordingly, the step S630 of controlling the first object recognition is a step for recognizing a distant object for the input image, and the first object recognition result means distant object recognition.

In addition, the step S620 of controlling the second object recognition generates a low-resolution image that is downsampled from the input image received at step S610, and in order to perform the second object recognition, delivers the downsampled low-resolution image to a second object recognition network. For example, as described above, the second object recognition network may be present in the server 200 or the infrastructure device 300 outside the moving object 100. Herein, as described above, the first object recognition network and the second object recognition network may be present in a same server or in different servers or infrastructure devices. Accordingly, the step S620 of controlling the second object recognition is a step for recognizing objects only within a distance that enables object recognition for the low-resolution input image. That is, the first object recognition result corresponding to the distant region may compensate for failure of recognition or a lowered recognition rate in the second object recognition result.

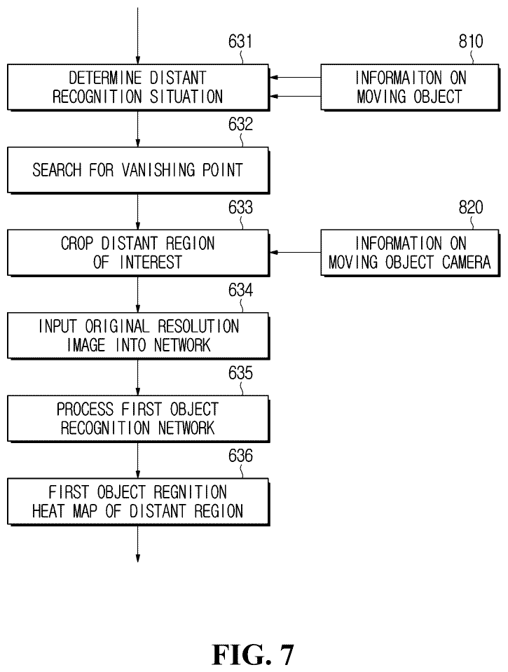

FIG. 7 illustrates a detailed flowchart of controlling first object recognition to derive the first object recognition result (S630), in accordance with an aspect of the present disclosure. The step S630 of controlling the first object recognition includes a step S631 of determining a distant recognition situation, which determines, by using moving object information, whether or not recognition of a distant object is necessary, if the recognition of the distant object is determined to be necessary, a step S632 of searching for a vanishing point, and then a step S633 of cropping a distant region of interest. In addition, the step S630 of controlling the first object recognition includes a step S634 of inputting the original resolution image of the specified distant region into the first object recognition network in order to perform the first object recognition. In addition, after performing the above-described first object recognition in the first object recognition network (S635), the step S630 of controlling the first object recognition includes receiving a first object recognition heat map of the distant region, which corresponds to the first object recognition result, from the first object recognition network (S636).

Specifically, the moving object information, which is used at step S631 of determining the distant recognition situation, may include at least one of location information, speed information, steering information, and heading indication information of a moving object. In this regard, the moving object may include the sensor unit 210 for obtaining the moving object information and obtain the moving object from the sensor unit 210 by sensing the moving object information. For example, the sensor unit 210 may be configured by including an inertial measuring device and sense an IMU signal that enables the speed, heading, gravitation, and acceleration of the moving object to be recognized as the moving object information.

Herein, at step S631 of determining the distant recognition situation, it is determined whether or not an autonomous moving object needs to recognize an object located at a distance. For example, by using its own speed information, the moving object may determine that the object located at a distance needs to be recognized in a high-speed driving environment. Alternatively, for example, while making a right turn or left turn at an intersection, the moving object may determine that another moving object approaching from a distance needs to be recognized.

In addition, at step S633 of cropping the distant region of interest, if it is determined that the distant object needs to be recognized, a distant vanishing point is searched first (S632). For example, in an image, a distant region has a high probability of being located at an image vanishing point formed by a lane or curb. In a situation of distant recognition, a vanishing point is searched and set as a reference point.

In order to crop the distant region of interest, pose information of a camera is checked using the above-described calibration information, a region of interest is set based on the vanishing point, and then an image of the region of interest is cropped in an original resolution. Herein, during the cropping process, scaling information on the region of interest may be stored, and the scaling information may mean information on a resolution ratio between the cropped original image and the above-described input image of downsampled image input network.

In this regard, a concrete method of setting the region of interest by reflecting the calibration information may be described as follows. For example, as for a moving object vehicle, a longitudinal front region from 55 m to 300 m, a transverse region from 10 m to −10 m, and a vertical region from −3 m to 8 m may set as a region of interest. Herein, the vertical region of the moving object vehicle is considered as a little higher region than a standard traffic light height of 5 m from the ground on the road since a road gradient is considered. For example, as illustrated in (a) of FIG. 5, a region 501 near a vanishing point may be set as the region of interest. For example, (b) of FIG. 5 illustrates a real original image of the region of interest 501, showing that all or some of moving object vehicles located on a reference line 503 of the front distant region of interest 501 may be set as a crop region 502. Herein, the cropped region of interest 502 retains the original high-resolution image and thus is maintained to be equal to or larger than a minimum recognition size in the above-described first object recognition network, so that distant first object recognition may be smoothly performed.

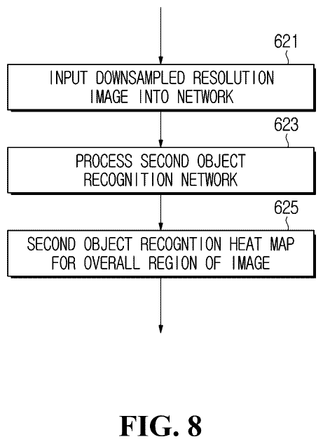

FIG. 8 illustrates a detailed flowchart of controlling second object recognition to derive the second object recognition result (S620), in accordance with an aspect of the present disclosure.

Specifically, the step S620 of controlling the second object recognition includes step S621 of inputting the downsampled resolution image of the input image into a second object recognition network in order to perform the second object recognition. In addition, after performing the above-described second object recognition in the second object recognition network (S623), the step S620 of controlling the second object recognition includes receiving a second object recognition heat map of an overall region of the input image, which corresponds to the second object recognition result, from the second object recognition network (S625).

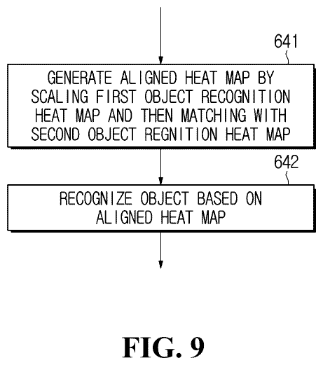

FIG. 9 illustrates a detailed flowchart of recognizing an object by matching the first object recognition result with the second object recognition result (S640), in accordance with an aspect of the present disclosure.

Specifically, the step S640 of recognizing an object (e.g., third objection recognition) includes generating an aligned heat map by scaling the first object recognition heat map of the distant region according to the scaling information and then matching the scaled first object recognition heat map with the second object recognition heat map for the overall region of the input image (S641) and performing final object recognition from the aligned heat map (S642).

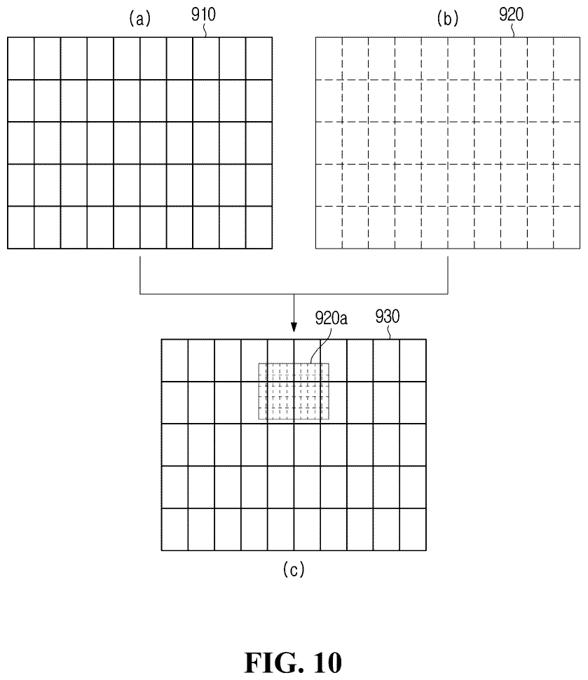

In this regard, FIG. 10 illustrates an example method of matching the first object recognition result with the second object recognition result in accordance with an aspect of the present disclosure. For example, (a) of FIG. 10 illustrates a second object recognition heat map result 910 for the overall image, and (b) of FIG. 10 illustrates a first object recognition heat map result 920 for the distant region. In addition, (c) of FIG. 10 illustrates an aligned heat map result 930 that matches the first object recognition heat map result with the second object recognition heat map result. Herein, the first object recognition heat map result 920 is scaled using the above-described scaling information (S920a) and then is marked in the finally aligned heat map result 930 by being matched with the second object recognition heat map result 910.

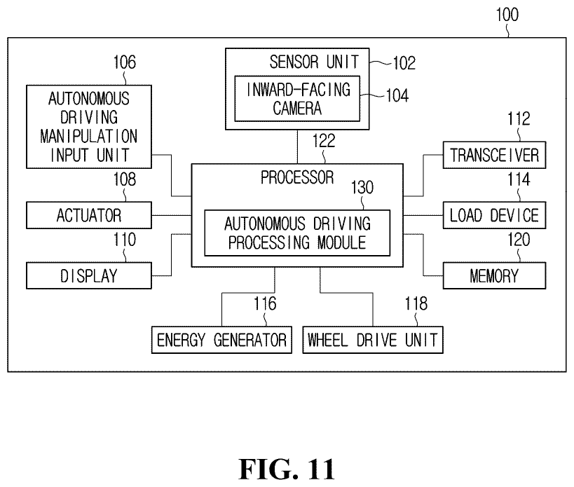

FIG. 11 illustrates an example of another detailed configuration of the autonomous driving moving object according to another aspect of the present disclosure. Referring to FIG. 11, the moving object 100 may be driven based on electric energy or fossil energy. In the case of electric energy, for example, the moving object 100 may be a pure battery-based moving object driven only by a high-voltage battery or employ a gas-based fuel cell as an energy source. In addition, the fuel cell may use various types of gas capable of generating electric energy, and for example, the gas may be hydrogen. However, without being limited thereto, various gases are applicable. In the case of fossil energy, the moving object 100 is driven based on fuels such as gasoline, diesel, or liquefied gas, and may be equipped with an engine that drives a wheel drive unit 118 by combustion of the fuel. The engine may be included in an energy generator 116 from a perspective of providing a driving torque of a wheel to the wheel drive unit 118.

For convenience of explanation, the present disclosure describes the moving object 100 as an example moving object based on electric energy, but except regenerative braking, charge, and discharge, an aspect of the present disclosure may certainly be applicable to a moving object based on fossil energy.

The moving object 100 may be driven by being controlled in autonomous driving, and the autonomous driving may be implemented as semi-autonomous driving or full autonomous driving. Full autonomous driving may be provided as autonomous moving under the complete control of the processor 122 of the moving object 100 without a user's intervention even in an uncertain driving situation. Semi-autonomous driving may be provided as autonomous moving that requires a driver's intervention in a specific driving situation. When the driving situation occurs, semi-autonomous driving may be implemented such that the processor 122 disables autonomous driving and switches control to the user, and thus the user performs manual driving. According to the autonomous driving levels defined by the Society of Automotive Engineers (SAE), semi-autonomous driving may correspond to the autonomous driving levels 1 to 4. The autonomous driving level 2 supports the autonomous driving controller 142 of the moving object 100 to assist both steering and acceleration/deceleration, and as an example, the autonomous driving level 2 may be implemented to execute such functions as lane following assist (LFA), lane keeping assist (LKA), highway driving assist (HDA) and smart cruise control (SCC) and to disable the functions for switching to manual driving in a specific driving situation. The autonomous driving level 3 may support lane change and overtaking functions like the autonomous driving level 2 and switch control to a driver in case of a dangerous situation. The autonomous driving level 4 may be configured to control an entire moving object by the autonomous driving controller 142 in response to each unexpected situation, while not requiring a driver's forward-looking responsibility, and to switch the control only in a remarkably uncertain situation like bad weather.

Specifically, the moving object 100 may include at least a sensor unit 102, an autonomous driving manipulation input unit 106, an actuator 108, and a display 110. In this regard, the sensor unit 102 may provide the same function as the sensor unit 210 of FIG. 2.

The sensor unit 102 may be equipped with various types of detectors for sensing various states and situations that occur in external and internal environments of the moving object 100. Specifically, the sensor unit 102 may be equipped with an outward-facing image sensor, a Lidar sensor, a radar sensor and the like to perceive dynamic and static objects present outside the moving object 100. The sensor unit 102 may be equipped with a location sensor, a gyro sensor, an acceleration sensor, a wheel sensor, an autometer, a speed sensor and the like to identify its own location, driving position, and speed. In addition, to monitor a user inside the moving object 100, a condition of an occupant, and an operating situation of an internal device of the moving object 100 that a user is capable of maneuvering, the sensor unit 102 may have an inward-facing camera 104, a biosensor for detecting biosignals of a driver and an occupant, and various detection modules for detecting the operation and state of an internal device. For example, the inward-facing camera 104 may be installed in a predetermined position inside the moving object or be built into the display 110. The inward-facing camera 104 may capture motions of various body parts of a driver and a passenger and deliver the captured motions to the processor 122. In addition, the processor 122 may estimate a user's physical condition through the received motion of a body part of the user or the passenger. For example, the physical condition may be a degree of fatigue of a driver and/or a passenger. In addition, a biosensor is provided as a contact-type sensor, which contacts a body part of a user to measure a biosignal, and may be configured in a pad form provided in a predetermined portion of, for example, a steering wheel and contacting a driver's hand or finger. For example, the biosensor may be configured to measure a user's pulse, blood pressure and ECG as biosignals or to acquire biosignals such as blood pressure and ECG indirectly based on biosignals that are directly measured. Based on biosignals acquired from the biosensor, a user tendency analysis and monitoring unit may estimate a physical condition such as the user's fatigue.

In order to enable a user such as a driver to activate or deactivate an autonomous driving function provided in the moving object 100, the autonomous driving manipulation input unit 106 may be configured as an interface to use or release an autonomous driving mode requested from the user. For example, the autonomous driving manipulation input unit 106 may be implemented as a hard-type interface provided in a predetermined position in the moving object 100 or a soft-type interface that is touchable on the display 100. In the case of a hard-type interface, for example, the autonomous driving manipulation input unit 106 may be installed on a steering wheel, a dashboard, and the like. The autonomous driving manipulation input unit 106 may be configured as an interface that enables a user to select various functions provided at a corresponding level of autonomous driving. As another example, the autonomous driving manipulation input unit 106 may receive a user's input requesting activation of an autonomous driving mode, and the processor 122 may execute a function suitable for a driving situation among functions of autonomous driving at a corresponding level, even if the user does not request any specific function. For example, as for the autonomous driving level 2, an option key may be provided as an interface for a plurality of functions such as LFA, LKA, HDA, and SCC.

The actuator 108 may be equipped with at least one module for implementing a driving operation and perform at least one driving operation of longitudinal control like acceleration/deceleration and transverse control like steering. The actuator 108 may be equipped with not only a pedal and a steering wheel accepting a user's request for the control but also various operating modules for generating a driving operation according to the request in the wheel drive unit 118.

The display 110 may serve as a user interface. By the processor 122, the display 110 may display an operating state and a control state of the moving object 100, path/traffic information, information on an energy remaining quantity, a content requested by a driver, and the like to be output. The display 110 may be configured as a touch screen capable of sensing a driver input and receive a request of a driver indicated to the processor 122.

Meanwhile, the moving object 100 may further include a transceiver 112, a load device 114, the energy generator 116, and the wheel drive unit 118.

For example, the transceiver 112 may support mutual communication with the server 200, the ITS device 300, and the neighbor moving object 400, which are described in FIG. 1. In the present disclosure, the transceiver 112 may transmit data generated or stored during driving to the server 200 and receive data and a software module transmitted from the server 200. In the present disclosure, the moving object 100 may transmit and receive data used in a method according to the present disclosure to and from the outside through the transceiver 112.

The load device 114 may be an auxiliary equipment mounted on the moving object 100, which consumes power supplied from the energy generator 116 by use of an occupant or user or converted from output of the energy generator 116. The load device 114 may be a type of electric device for non-driving purpose excluding a driving power system like the wheel drive unit 118 in the present disclosure. For example, the load device 114 may be various devices installed in an air-conditioning system, a light system, a seat system and the moving object 100.

The energy generator 116 may generate and supply power and electricity used for a driving power system like the wheel drive unit 118 and the load device 114. In case the moving object 100 is driven based on electric energy, for example, the energy generator 116 may be configured as an electric battery or be configured as a combination of an electric battery and a fuel cell for charging the battery. In the case of a combination of an electric battery and a fuel cell, the energy generator 116 may include a tank for storing a material used to produce power of the fuel cell, for example, hydrogen gas. In case the moving object 100 is driven based on fossil energy, the energy generator 116 may be configured as an internal combustion engine.

The wheel drive unit 118 may include a plurality of wheels, a driving force transfer module for generating and giving a driving force to wheels or for transferring a driving force, a braking module for decelerating the driving of wheels, and a steering module for realizing transverse control of wheels. In case the moving object 100 is driven based on electric energy, the driving force transfer module may be configured as a motor module that generates a driving force based on power output from an electric battery. In case the moving object 100 is operated based on fossil energy, a driving force transfer module may be equipped with transmission and a gear module that transfer power of an internal combustion engine.

In addition, the moving object 100 may include the memory 120 and the processor 122. The memory 120 may store an application for controlling the moving object 100 and various data and load the application or read and record data at a request of the processor 122. In the present disclosure, the memory 120 may store an application and at least one instruction for recognizing an object (including a distant object) on a driving path of the moving object 100 controlled in an autonomous driving mode and/or predicting a motion thereof and using the motion in establishing a path plan of the moving object.

To this end, for example, the memory 120 may store and manage driving history information of a user (or driver) of the moving object 100, map information, and the like. The map information stored in the memory 120 may be used to create a driving path set to the moving object 100 at a request of a user or the processor 122. In addition, the map information may be used for autonomous driving and include a low definition map or include an HD map together with the map. The map information may be provided to have various information and data included in the driving environment information.

The processor 122 may perform overall control of the moving object 100. The processor 122 may be configured to execute an application and an instruction stored in the memory 120. In relation to the present disclosure, the processor 122 is capable of perform the above-described operations of FIG. 3 to FIG. 10.

An object recognition method capable of recognizing a distant object in a moving object includes specifying a distant region by cropping the distant region in an input image and controlling first object recognition for an original resolution image of the specified distant region, controlling second object recognition for a down-sampled resolution image of the input image, and performing object recognition by matching a result of the first object recognition with a result of the second object recognition.

In addition, the controlling of the first object recognition includes inputting the original resolution image of the specified distant region into a first object recognition network in order to perform the first object recognition.

In addition, the controlling of the second object recognition includes inputting the down-sampled resolution image of the input image into a second object recognition network in order to perform the second object recognition.

In addition, the controlling of the first object recognition further includes determining whether or not recognition of a distant object is necessary, by using information on the moving object.

The information on the moving object may include at least one of location information, speed information, steering information, and heading indication information of the moving object.

In addition, the controlling of the first object recognition further includes searching for a vanishing point and then cropping a distant region of interest, when the recognition of the distant object is determined to be necessary.

In addition, the cropping of the region of interest sets the region of interest with the vanishing point as a reference point by reflecting camera calibration information in the moving object and sets the region of interest by an original resolution image. In addition, the cropping of the region of interest may further include storing scaling information of the region of interest with the original resolution image.

In addition, the controlling of the first object recognition further includes receiving a first object recognition heat map of the distant region from the first object recognition network. On the other hand, the controlling of the second object recognition may further include receiving a second object recognition heat map for an overall region of the input image.

In addition, the performing of the object recognition by matching the result of the first object recognition and the result of the second object recognition may include generating an aligned heat map by scaling the first object recognition heat map of the distant region according to the scaling information and then matching the scaled first object recognition heat map with the second object recognition heat map for the overall region of the input image and performing the object recognition from the aligned heat map.

A moving object capable of distant object recognition includes a memory storing a computer-readable instruction and at least one processor that is operated by the instruction, and the instruction instructs the at least one processor to specify a distant region by cropping the distant region in an input image and control first object recognition for an original resolution image of the specified distant region, to control second object recognition for a down-sampled resolution image of the input image, and to perform object recognition by matching a result of the first object recognition with a result of the second object recognition.

In addition, the at least one processor delivers the original resolution image of the specified distant region to a first object recognition network in order to perform the first object recognition. In addition, the at least one processor may deliver the down-sampled resolution image of the input image to a second object recognition network in order to perform the second object recognition.

In addition, the moving object further includes a sensor unit for obtaining information on a moving object, and the at least one processor determines whether or not recognition of a distant object is necessary, by using the information on the moving object that is recognized from the sensor unit.

The information on the moving object may include at least one of location information, speed information, steering information, and heading indication information of the moving object.

In addition, the at least one processor may search for a vanishing point and then crop a distant region of interest, when the recognition of the distant object is determined to be necessary.

In addition, the moving object may further include a camera for obtaining an image, and the at least one processor may set the region of interest with the vanishing point as a reference point by reflecting calibration information of the camera and set the region of interest by an original resolution image.

In addition, the at least one processor may store scaling information of the region of interest with the original resolution image.

In addition, the at least one processor may receive a first object recognition heat map of the distant region from the first object recognition network. In addition, the at least one processor may receive a second object recognition heat map for an overall region of the input image.

In addition, at least one processor may generate an aligned heat map by scaling the first object recognition heat map of the distant region according to the scaling information and then matching the scaled first object recognition heat map with the second object recognition heat map for the overall region of the input image and perform the object recognition from the aligned heat map.

The features briefly summarized above with respect to the present disclosure are merely exemplary aspects of the detailed description of the present disclosure that follows, and do not limit the scope of the present disclosure.

According to the present disclosure, object recognition in a distant region may be possible in a moving object capable of autonomous driving.

According to the present disclosure, recall performance for recognition of an object in a distant region of interest may be possible by using original image resolution compensation.

The various examples of the present disclosure are not intended to list all possible combinations but to illustrate representative aspects of the present disclosure. The matters described in the various examples may be applied independently or in a combination of two or more.

Also, the various features of the present disclosure may be implemented by hardware, firmware, software, or a combination thereof. With hardware implementation, the features may be implemented by using at least one or more of a group of application specific integrated circuits (ASICs), digital signal processors (DSPs), digital signal processing devices (DSPDs), programmable logic devices (PLDs), field programmable gate arrays (FPGAs), general-purpose processors, controllers, micro controllers, and micro processors.

The scope of the present disclosure includes software or machine-executable instructions (for example, an operating system, an application, firmware, a program, etc.), which cause an operation according to the methods of the various examples to be performed on a device or a computer, and includes a non-transitory computer-readable medium storing such software or instructions to execute on a device or a computer.

What is claimed is:

1. A method performed by an apparatus of a vehicle, the method comprising:
obtaining, via a camera of the vehicle, an image of an exterior view from the vehicle;
generating a cropped image of a distant region in the obtained image;
performing first object recognition on the cropped image of the distant region, wherein the cropped image has an original resolution of the obtained image;
performing second object recognition on a processed image associated with the obtained image, wherein the processed image has a down-sampled resolution of the obtained image;
performing third object recognition by matching a result of the first object recognition with a result of the second object recognition; and
controlling, based on a result of the third object recognition, an operation of the vehicle.

2. The method of claim 1, wherein the performing of the first object recognition comprises inputting the cropped image having the original resolution into a first object recognition network.

3. The method of claim 2, wherein the performing of the second object recognition comprises inputting the processed image having the down-sampled resolution into a second object recognition network.

4. The method of claim 2, wherein the performing of the first object recognition further comprises determining, based on information associated with the vehicle, whether recognition of a distant object is necessary.

5. The method of claim 4, wherein the information associated with the vehicle comprises at least one of: location information, speed information, steering information, or heading indication information.

6. The method of claim 1, wherein the generating of the cropped image comprises:
determining a vanishing point in the obtained image; and
determining the distant region by determining a region of interest that comprises the vanishing point.

7. The method of claim 6, wherein the determining of the distant region comprises:
setting, based on camera calibration information of the vehicle, the vanishing point as a reference point for the region of interest having the original resolution.

8. The method of claim 7, wherein the determining of the distant region further comprises storing scaling information of the region of interest with the original resolution.

9. The method of claim 1, wherein the performing of the first object recognition comprises receiving, based on a first object recognition network, a first object recognition heat map of the distant region.

10. The method of claim 9, wherein the performing of the second object recognition comprises receiving a second object recognition heat map for an overall region of the obtained image.

11. The method of claim 10, wherein the performing of the third object recognition comprises:
generating an aligned heat map by:
scaling the first object recognition heat map of the distant region according to scaling information of the distant region; and
matching the scaled first object recognition heat map with the second object recognition heat map for the overall region; and
performing, based on the aligned heat map, the third object recognition.

12. A vehicle comprising:
a camera;
memory storing computer-readable instructions; and
at least one processor configured to execute the computer-readable instructions to cause the vehicle to:
obtain, via the camera, an image of an exterior view from the vehicle;
generate a cropped image of a distant region in the obtained image;
perform first object recognition on the cropped image of the distant region, wherein the cropped image has an original resolution of the obtained image;
perform second object recognition on a processed image associated with the obtained image, wherein the processed image has a down-sampled resolution of the obtained image;
perform third object recognition by matching a result of the first object recognition with a result of the second object recognition; and
control, based on a result of the third object recognition, an operation of the vehicle.

13. The vehicle of claim 12, wherein the at least one processor is configured to execute the computer-readable instructions to cause the vehicle to perform the first object recognition by inputting the cropped image having the original resolution to a first object recognition network.

14. The vehicle of claim 13, wherein the at least one processor is configured to execute the computer-readable instructions to cause the vehicle to perform the second object recognition by inputting the processed image having the down-sampled resolution to a second object recognition network.

15. The vehicle of claim 13, further comprising a sensor for obtaining information associated with the vehicle,
wherein the at least one processor is configured to execute the computer-readable instructions to cause the vehicle to perform the first object recognition further by determining, based on the information associated with the vehicle, whether recognition of a distant object is necessary.

16. The vehicle of claim 15, wherein the information associated with the vehicle comprises at least one of: location information, speed information, steering information, or heading indication information.

17. The vehicle of claim 12, wherein the at least one processor is configured to execute the computer-readable instructions to cause the vehicle to generate the cropped image by:
determining a vanishing point in the obtained image; and
determining the distant region by determining a region of interest that comprises the vanishing point.

18. The vehicle of claim 17, wherein the at least one processor is configured to execute the computer-readable instructions to cause the vehicle to determine the distant region by:
setting, based on camera calibration information of the vehicle, the vanishing point as a reference point for the region of interest having the original resolution.

19. The vehicle of claim 18, wherein the at least one processor is configured to execute the computer-readable instructions to cause the vehicle to determine the distant region by storing scaling information of the region of interest with the original resolution.

20. The vehicle of claim 19, wherein the at least one processor is configured to execute the computer-readable instructions to cause the vehicle to perform the first object recognition by receiving, based on a first object recognition network, an object recognition heat map of the distant region.
